(19) United States
(12) Patent Application Publication
(10) Pub. No.: US 2023/0136545 A1
(43) Pub. Date: May 4, 2023

(54) DIRECTIONAL ACOUSTIC DEVICE

(71) Applicant: Apple Inc., Cupertino, CA (US)

(72) Inventors: Daniel K. BOOTHE, San Francisco, CA (US); Onur I. ILKORUR, Santa Clara, CA (US); Marty E. JOHNSON, Los Gatos, CA (US); Chris WILK, Los Gatos, CA (US); Jason T. PARKER, San Francisco, CA (US); Tom-Davy W. SAUX, Los Gatos, CA (US)

(21) Appl. No.: 17/966,752

(22) Filed: Oct. 14, 2022

Related U.S. Application Data
(60) Provisional application No. 63/274,505, filed on Nov. 1, 2021.

(51) Int. Cl. H04R 1/34; H04R 1/28; H04R 5/02

(52) U.S. Cl. CPC H04R 1/345; H04R 1/2826; H04R 5/02; H04R 2499/13

(57) ABSTRACT

Implementations of the subject technology provide directional acoustic devices such as directional speakers. A directional speaker may include a sound-generating component that projects sound from an acoustic port, and has a rear or interior surface that interfaces with a back volume of the speaker. The directional speaker may also include one or more acoustic ducts coupled to the back volume that direct a negative polarity version of the sound to one or more desired locations in an external environment of the speaker. The negative polarity version of the sound may cancel portions of the sound projected from the acoustic port, at one or more desired locations in the external environment that are determined by the arrangement of the acoustic duct(s).

### CROSS REFERENCE TO RELATED APPLICATIONS

This application claims the benefit of priority to U.S. Provisional Patent Application No. 63/274,505, entitled, “Directional Acoustic Device”, filed on Nov. 1, 2021, the disclosure of which is hereby incorporated herein in its entirety.

### TECHNICAL FIELD

The present description relates generally to acoustic devices, including, for example, a directional acoustic device.

### BACKGROUND

Acoustic devices can include speakers that generate sound and microphones that detect sound.

### BRIEF DESCRIPTION OF THE DRAWINGS

Certain features of the subject technology are set forth in the appended claims. However, for purpose of explanation, several embodiments of the subject technology are set forth in the following figures.

FIGS. 1 and 2 illustrate aspects of an example apparatus in accordance with one or more implementations.

FIG. 3 illustrates a schematic perspective view of an example directional acoustic device in accordance with implementations of the subject technology.

FIG. 4 illustrates a schematic perspective view of an example directional component of a directional acoustic device in accordance with implementations of the subject technology.

FIG. 5 illustrates a schematic side view of another example directional acoustic device in accordance with implementations of the subject technology.

FIG. 6 illustrates a schematic top view of an example of directional audio output by the example directional acoustic device of FIG. 5, implemented in the apparatus of FIG. 1, in accordance with implementations of the subject technology.

FIG. 7 illustrates an example three-dimensional acoustic power distribution of directional audio output of the example directional acoustic device of FIG. 5 in accordance with implementations of the subject technology.

FIG. 8 illustrates an example distribution of acoustic power as a function of frequency and azimuth of directional audio output by the example directional acoustic device of FIG. 5 in accordance with implementations of the subject technology.

FIG. 9 illustrates a schematic top view of another example directional acoustic device in accordance with implementations of the subject technology.

FIG. 10 illustrates a schematic top view of another example directional acoustic device in accordance with implementations of the subject technology.

FIGS. 11 and 12 illustrate two example out-of-phase operational modes of the example directional acoustic device of FIG. 10 in accordance with implementations of the subject technology.

FIG. 13 illustrates a flow chart of example operations that may be performed for directional audio output in accordance with implementations of the subject technology.

FIG. 14 illustrates another flow chart of example operations that may be performed for directional audio output in accordance with implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Implementations of the subject technology described herein provide a directional acoustic device that can be implemented in various environments and/or apparatuses, such as apparatuses that include an enclosed environment. In one or more implementations, the directional acoustic device may be a directional speaker. A directional speaker, as described herein, may be a speaker that has an acoustic port through which sound (e.g., generated by a moving diaphragm or other sound-generating component) is projected, a back volume, and an elongated channel fluidly coupled to the back volume and configured to output sound from the back volume. Because the sound from the back volume will have a polarity (e.g., a negative polarity) that is opposite to a polarity (e.g., a positive polarity) output from the acoustic port, the sound from the back volume may cancel a portion of the sound from the acoustic port, in a direction defined by the arrangement of the elongated channel. In one or more implementations, a directional speaker may have more than one elongated channel fluidly coupled to the rear volume of the speaker.

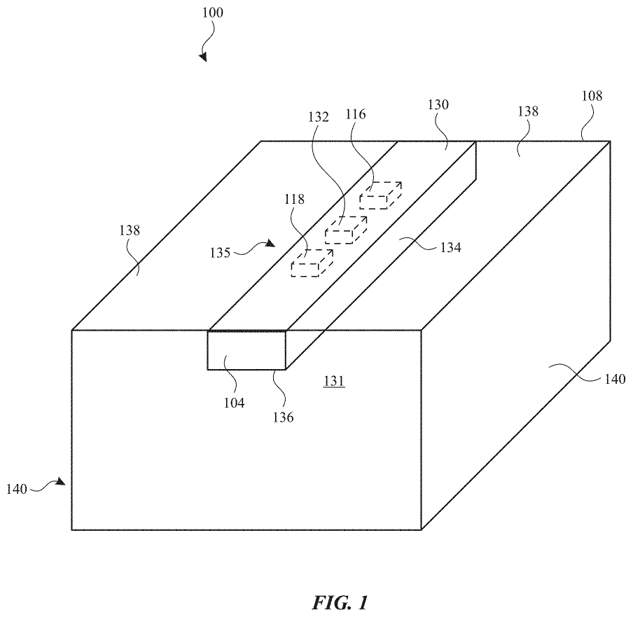

An illustrative apparatus including a directional acoustic device is shown in FIG. 1. In the example of FIG. 1, an apparatus 100 includes an enclosure 108 and a support structure 104. The enclosure may (e.g., at least partially) define an enclosed environment 131. In the example of FIG. 1, the enclosure 108 includes top housing structures 138 mounted to and extending from opposing sides of the support structure 104, and a sidewall housing structure 140 extending from each top housing structure 138.

In this example, the enclosure 108 is depicted as a rectangular enclosure in which the sidewall housing structures 140 are attached at an angle to a corresponding top housing structure 138. However, it is also appreciated that this arrangement is merely illustrative, and other arrangements are contemplated. For example, in one or more implementations, the top housing structure 138 and the sidewall housing structure 140 on one side of the support structure 104 may be formed from a single (e.g., monolithic) structure having a bend or a curve between a top portion (e.g., corresponding to a top housing structure 138) and a side portion (e.g., corresponding to a sidewall housing structure 140). For example, in one or more implementations, the top housing structure 138 and the sidewall housing structure 140 on each side of the support structure 104 may be formed from a curved glass structure. In this and/or other implementations, the sidewall housing structure 140 and/or other portions of the enclosure 108 may be or include a reflective surface (e.g., an acoustically reflective surface).

As illustrated in FIG. 1, the apparatus 100 may include various components such as one or more safety components 116, one or more speakers 118, and/or one or more other components 132. In the example of FIG. 1, the safety component 116, the speaker 118, and the other component 132 are mounted in a structural space 130 at least partially within the support structure 104. The other component 132 may include, as examples, one or more cameras, and/or one or more sensors. However, it is also contemplated that one or more safety components 116, one or more speakers 118, and/or one or more other components 132 may also, and/or alternatively, be mounted to the enclosure 108, and/or to and/or within one or more other structures of the apparatus 100. As shown in FIG. 1, the support structure 104 may include a first side 134, an opposing second side 135, and a bottom surface 136 that faces an interior of the enclosed environment 131 defined by the enclosure 108.

In various implementations, the apparatus 100 may be implemented as a stationary apparatus (e.g., a conference room or other room within a building) or a moveable apparatus (e.g., a vehicle such as an autonomous or semiautonomous vehicle, a train car, an airplane, a boat, a ship, a helicopter, etc.) that can be temporarily occupied by one or more human occupants. In one or more implementations, (although not shown in FIG. 1), the apparatus 100 may include one or more seats for one or more occupants. In one or more implementations, one or more of the seats may be mounted facing in the same direction as one or more other seats, and/or in a different (e.g., opposite) direction of one or more other seats.

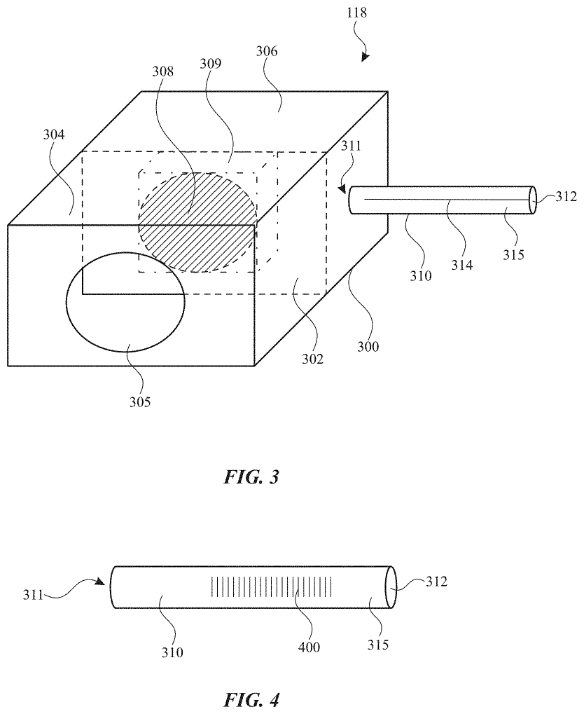

In one or more use cases, it may be desirable to provide audio content to one or more occupants within the enclosed environment 131. The audio content may include general audio content intended for all of the occupants and/or personalized audio content for one or a subset of the occupants. For example, in implementations in which the apparatus 100 is a moveable apparatus, it may be desirable to notify a particular occupant that their stop is upcoming or that the apparatus 100 has arrived at their stop, without conveying that notification to other occupants within the enclosed space. In these and/or other use cases, it may be desirable to be able to direct the audio content, or a portion of the audio content, to one or more particular locations within the enclosed environment 131 and/or to suppress the audio content and/or a portion of the audio content at one or more other particular locations within the enclosed environment 131. In one or more implementations, the speaker 118 may be implemented as a directional speaker (which may also be referred to herein as a rear shotgun speaker), as discussed in further detail hereinafter in connection with FIGS. 3-14.

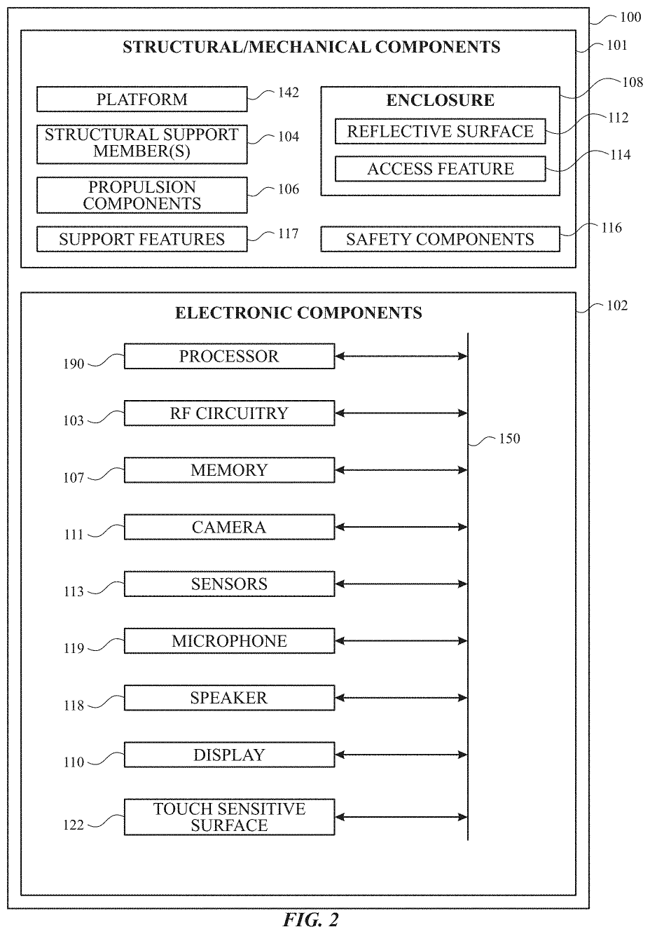

In various implementations, the apparatus 100 may include one or more other structure, mechanical, electronical, and/or computing components that are not shown in FIG. 1. For example, FIG. 2 illustrates a schematic diagram of the apparatus 100 in accordance with one or more implementations.

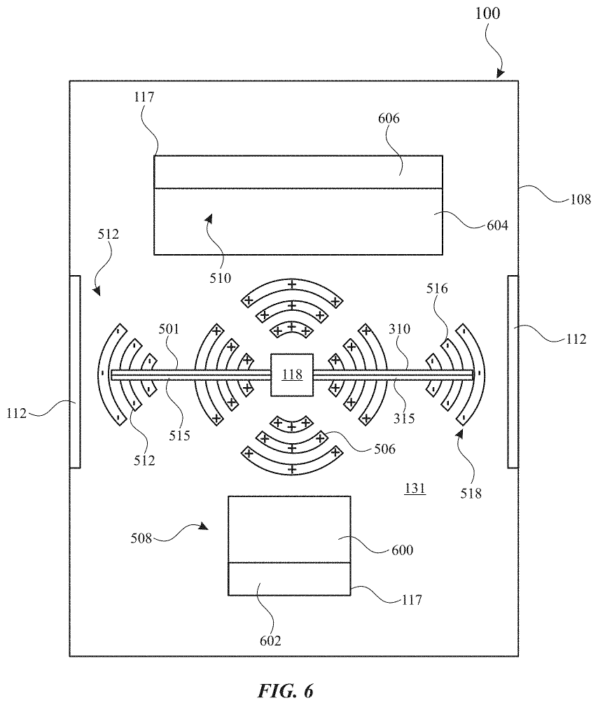

As shown in FIG. 2, the apparatus 100 may include structural and/or mechanical components 101 and electronic components 102. In this example, the structural and/or mechanical components 101 include the enclosure 108, the support structure 104, and the safety component 116 of FIG. 6. In this example, the structural and/or mechanical components 101 also include a platform 142, propulsion components 106, and support features 117. In this example, the enclosure 108 includes a reflective surface 112 and an access feature 114.

As examples, the safety components 116 may include one or more seatbelts, one or more airbags, a roll cage, one or more fire-suppression components, one or more reinforcement structures, or the like. As examples, the platform 142 may include a floor, a portion of the ground, or a chassis of a vehicle. As examples, the propulsion components may include one or more drive system components such as an engine, a motor, and/or one or more coupled wheels, gearboxes, transmissions, or the like. The propulsion components may also include one or more power sources such as fuel tank and/or a battery. As examples, the support feature 117 may be support features for occupants within the enclosed environment 131 of FIG. 1, such as one or more seats, benches, and/or one or more other features for supporting and/or interfacing with one or more occupants. As examples, the reflective surface 112 may be a portion of a top housing structure 138 or a sidewall housing structure 140 of FIG. 1, such as a glass structure (e.g., a curved glass structure). As examples, the access feature 114 may be a door or other feature for selectively allowing occupants to enter and/or exit the enclosed environment 131 of FIG. 1.

As illustrated in FIG. 2, the electronic components 102 may include various components, such as a processor 190, RF circuitry 103 (e.g., WiFi, Bluetooth, near field communications (NFC) or other RF communications circuitry), memory 107, a camera 111 (e.g., an optical wavelength camera and/or an infrared camera, which may be implemented in the other components 132 of FIG. 1), sensors 113 (e.g., an inertial sensor, such as one or more accelerometers, one or more gyroscopes, and/or one or more magnetometers, radar sensors, ranging sensor such as LIDAR sensors, depth sensors, temperature sensors, humidity sensors, etc. which may also be implemented in the other components 132 of FIG. 1), a microphone 119, a speaker 118, a display 110, and a touch-sensitive surface 122. These components optionally communicate over a communication bus 150. Although a single processor 190, RF circuitry 103, memory 107, camera 111, sensor 113, microphone 119, speaker 118, display 110, and touch-sensitive surface 122 are shown in FIG. 2, it is appreciated that the electronic components 102 may include one, two, three, or generally any number of processors 190, RF circuitry 103, memories 107, cameras 111, sensors 113, microphones 119, speakers 118, displays 110, and/or touch-sensitive surfaces 122.

In the example of FIG. 2, apparatus 100 includes a processor 190 and memory 107. Processor 190 may include one or more general processors, one or more graphics processors, and/or one or more digital signal processors. In some examples, memory 107 may include one or more non-transitory computer-readable storage mediums (e.g., flash memory, random access memory, volatile memory, non-volatile memory, etc.) that store computer-readable instructions configured to be executed by processor 190 to perform the techniques described below (e.g., including operating the speaker 118).

RF circuitry 103 optionally includes circuitry for communicating with electronic devices, networks, such as the Internet, intranets, and/or a wireless network, such as cellular networks and wireless local area networks (LANs). RF circuitry 103 optionally includes circuitry for communicating using near-field communication and/or short-range communication, such as Bluetooth®.

Display 110 may incorporate LEDs, OLEDs, a digital light projector, a laser scanning light source, liquid crystal on silicon, or any combination of these technologies. Examples of display 110 include head up displays, automotive windshields with the ability to display graphics, windows with the ability to display graphics, lenses with the ability to display graphics, tablets, smartphones, and desktop or laptop computers. In one or more implementations, display 110 may be operable in combination with the speaker 118 and/or with a separate display (e.g., a display of a smartphone, a tablet device, a laptop computer, a smart watch, or other device) of a separate device within the enclosed environment 131.

Touch-sensitive surface 122 may be configured for receiving user inputs, such as tap inputs and swipe inputs. In some examples, display 110 and touch-sensitive surface 122 form a touch-sensitive display.

Camera 111 optionally includes one or more visible light image sensors, such as charged coupled device (CCD) sensors, and/or complementary metal—oxide—semiconductor (CMOS) sensors operable to obtain images within the enclosed environment 131 and/or of an environment external to the enclosure 108. Camera 111 may also optionally include one or more infrared (IR) sensor(s), such as a passive IR sensor or an active IR sensor, for detecting infrared light from within the enclosed environment 131 and/or of an environment external to the enclosure 108. For example, an active IR sensor includes an IR emitter, for emitting infrared light. Camera 111 also optionally includes one or more event camera(s) configured to capture movement of objects such as occupants within the enclosed environment 131 and/or objects such as vehicles, roadside objects and/or pedestrians outside the enclosure 108. Camera 111 also optionally includes one or more depth sensor(s) configured to detect the distance of physical elements from the enclosure 108 and/or from other objects within the enclosed environment 131. In some examples, camera 111 includes CCD sensors, event cameras, and depth sensors that are operable in combination to detect the physical setting around apparatus 100.

In some examples, sensors 113 may include radar sensor(s) configured to emit radar signals, and to receive and detect reflections of the emitted radar signals from one or more objects in the environment around the enclosure 108. In some examples, one or more microphones such as microphone 119 may be provided to detect sound from an occupant within the enclosed environment 131 and/or from one or more audio sources external to the enclosure 108. In some examples, microphone 119 includes an array of microphones that optionally operate in tandem, such as to identify ambient noise or to locate the source of sound in space.

Sensors 113 may also include positioning sensors for detecting a location of the apparatus 100, and/or inertial sensors for detecting an orientation and/or movement of apparatus 100. For example, processor 190 of the apparatus 100 may use inertial sensors and/or positioning sensors (e.g., satellite-based positioning components) to track changes in the position and/or orientation of apparatus 100, such as with respect to physical elements in the physical environment around the apparatus 100. Inertial sensor(s) of sensors 113 may include one or more gyroscopes, one or more magnetometers, and/or one or more accelerometers.

As discussed herein, speaker 118 may be implemented as a directional speaker, in one or more implementations. FIG. 3 illustrates a perspective view of an example directional speaker, in accordance with one or more implementations. As shown in FIG. 3, in one or more implementations, an acoustic device, such as speaker 118, may include a diaphragm 308 mounted in a housing 300. In the example of FIG. 3, speaker 118 includes a front volume 304 on a first side of the diaphragm 308 and a back volume 306 on an opposing second side of the diaphragm 308 and at least partially defined by the housing 300. For example, the diaphragm may be mounted to an interior structure 302 of the speaker 118, and the interior structure and the diaphragm 308 may sealingly separate the front volume 304 from the back volume 306. The interior structure may be an interior wall, and/or may include a surround that extends around a peripheral edge of the diaphragm and/or a portion of a mounting structure (e.g., a basket) for the diaphragm and/or surround.

As shown, speaker components 309 may be disposed within the back volume 306. As examples, the speaker components 309 may include a magnet, a voice coil, and/or structural components of the speaker 118. In one or more implementations, a voice coil of the speaker 118 may be communicatively coupled to the processor 190 of FIG. 2. The processor 190 may generate control signals that cause a current through the voice coil that, in turn, causes movement of the diaphragm 308 that generates sound or audio output from the speaker 118.

As shown in FIG. 3, the speaker 118 may include an acoustic port 305 fluidly coupling the front volume 304 to an external environment of the speaker 118. Sound generated by motion of diaphragm 308 may be projected from the speaker 118 via the acoustic port 305. In the example of FIG. 3, the front volume 304 is defined by in part by the diaphragm 308 and the interior structure 302 and in part by a portion of the housing 300 that extends forward from the diaphragm 308. However, in other implementations, the housing 300 may extend around the back volume 306 and only up to the interior structure 302 and/or the diaphragm 308 such that the front volume 304 is a volume defined by a curved surface of the diaphragm and such that acoustic port 305 is defined by the peripheral edge of the diaphragm 308 itself.

As shown in FIG. 3, an acoustic device such as the speaker 118 may include a channel housing 310 extending from the housing 300. The channel housing 310 may be a separate housing that is attached to the housing 300 or may be an integral extension of the housing 300, in various implementations. The channel housing 310 (e.g., an interior surface of the channel housing 310) defines an elongated channel 315 within the channel housing 310 with a first end 311 that is fluidly coupled to the back volume 306 and a second end 312 that is fluidly coupled to the external environment of the speaker 118. As shown, the channel housing 310 includes a slot 314 that fluidly couples the elongated channel 315 with the external environment, at a location between the first end 311 and the second end 312. Although a single slot 314 is visible in the example of FIG. 3, the channel housing 310 may include multiple slots 314 (e.g., two slots 314 symmetrically disposed on opposing sides of the channel housing, three slots 314, or more than three slots 314).

In the example of FIG. 3, the slot 314 extends along the length of the channel housing 310 in parallel with a longitudinal axis of the channel housing 310 and the elongated channel 315 defined therein. FIG. 4 illustrates another example of the channel housing 310 in which multiple slots 400 are instead provided in the channel housing 310. In the example of FIG. 4, the slots 400 are oriented transversely to the longitudinal axis of the channel housing 310 and are spaced apart along the length of the channel housing 310 in a direction that is parallel with the longitudinal axis of the channel housing 310 and the elongated channel 315 defined therein. In various implementations, the channel housing 310 may include one or more longitudinal slots such as the slot 314 of FIG. 3 and/or one or more transverse slots such as the slots 400 of FIG. 4.

In the examples of FIGS. 3 and 4, the slot 314 has a uniform slot width along the elongated channel 315, and the slots 400 are uniformly shaped and uniformly spaced along the elongated channel. For example, a uniform slot width may be implemented to form as narrow a projected beam as possible at all frequencies. In these uniform slot-width implementations, the projected beam becomes monotonically narrower as frequency increases. However, it is also appreciated that a longitudinal slot such as the slot 314 may have a slot width that changes along the length of the elongated channel 315, and/or the slots 400 may have transverse slot lengths and/or longitudinal slot widths that change (e.g., from one slot 400 to a next slot 400) along the length of the elongated channel 315. For example, an expanding slot width (e.g., expanding along the length of the elongated channel 315) can be implemented to generate a projected beam that settles at a particular beam width, such that the directivity of the projected beam is more constant with frequency.

For example, in one or more implementations, one or more longitudinal slots, such as the slot 314 of FIG. 3, may be implemented as an expanding slot having a slot width that is relatively narrow at a proximal slot end nearer to the housing 300 and expands in a direction parallel to the longitudinal axis of the channel housing 310 (e.g., and the elongated channel 315 defined therein) toward a distal slot end further from the housing 300. In one or more implementations, the slot width can increase uniformly along the length of the channel housing 310 (e.g., at a constant expansion angle of between thirty degrees and sixty degrees, or at another constant expansion angle). In one or more other implementations, the slot width can have non-variations along the length of the channel housing 310. It is appreciated that the exact expansion profile of a slot can be tailored for a particular implementation, to create a desired directivity of the negative polarity sound projected from the elongated channel 315.

In one or more implementations, the slot 314, and/or one or more transverse slots such as the slots 400, may be covered by an acoustic mesh. In one or implementations, an acoustic mesh that covers the slot 314 and/or one or more transverse slots such as the slots 400 may have an acoustic resistance value that changes along the length of the elongated channel 315 (e.g., along a direction parallel to the longitudinal axis of the channel housing 310). For example, providing an acoustic mesh with an acoustic resistance value that changes along the length of the elongated channel 315 may help improve the directionality of the channel (e.g., as a function of frequency).

Because the front volume 304 and the back volume 306 are disposed on opposing sides of the diaphragm 308, pressure changes generated, by the motion of the diaphragm 308, in the front volume 304 have a polarity that is opposite to pressure changes on in the back volume 306. That is, when the diaphragm 308 moves forward and compresses the air in front of the diaphragm (e.g., in the front volume 304), the diaphragm 308 simultaneously expands the volume of the back volume 306, decompressing the air in the back volume. For this reason, sound generated with a positive polarity in the front volume 304 (e.g., and projected through the acoustic port 305) is also generated with a negative polarity in the back volume 306.

In one or more implementations, the channel housing 310 and the elongated channel 315 defined therein direct a portion of the negative polarity sound generated in the back volume 306 to a location that is defined by the orientation of the elongated channel 315. In the examples of FIGS. 3 and 4, the slot 314 and/or the slots 400 allow portions of the negative polarity sound to leak out of (e.g., exit) the elongated channel to the external environment at various locations along the length of the elongated channel. Because the negative polarity sound that exits the slot(s) leaks out of the elongated channel to at various distances from the source of the sound, the negative polarity sound exits with varied phases that substantially cancel out the negative polarity sound in a direction perpendicular to the longitudinal axis of the elongated channel 315. In this way, the elongated channel 315 directs the negative polarity sound through the second end 312 in a direction of the longitudinal axis of the elongated channel. Moreover, because the sound directed in the direction of the longitudinal axis is negative in polarity with respect to the positive polarity sound projected from the acoustic port 305, a portion of the positive polarity sound projected from the acoustic port 305 that propagates into the region of the external environment in which the negative polarity sound is directed (by the elongated channel 315) will be at least partially cancelled in that region. Thus, the speaker 118 of FIG. 3 can generate audible sound in some parts of the environment and a zone of quiet in another part of the environment.

Thus, in the example of FIG. 3, the speaker 118 is configured to project positive polarity sound, generated by a motion of the diaphragm 308, through the acoustic port 305, and to project negative polarity sound, generated by the motion of the diaphragm 308, through the elongated channel 315. In this example, the positive polarity sound, when projected through the acoustic port 305, generates audible sound in a first region of the external environment of the speaker 118, and the negative polarity sound, when projected through the elongated channel 315, cancels at least a portion of the positive polarity sound in a second region of the external environment.

In the example of FIG. 3, the acoustic port 305 is aligned in a first direction and the elongated channel 315 is aligned in a second direction substantially perpendicular to the first direction. However, this is merely illustrative. In other implementations, the channel housing 310 and/or the elongated channel 315 defined therein can be oriented in any direction (relative to the first direction in which the acoustic port 305 is aligned) in which it is desired to cancel or suppress some or all of the sound emitted from the acoustic port 305.

In the examples of FIGS. 3 and 4, the channel housing 310 is a cylindrical housing having a cylindrical interior cavity that defines a cylindrical elongated channel. However, in other implementations, the shape of the channel housing and/or the elongated channel defined therein can be rectilinear or can be implemented in any other arrangement with an elongated dimension and various cross-sectional shapes. In one or more implementations, the channel housing 310 and/or the elongated channel 315 defined therein can have a length that is similar to or substantially larger than a diameter of the diaphragm 308. For example, diaphragm 308 may have a diameter of less than one inch, or between one inch and ten inches (as examples), and the channel housing 310 and/or the elongated channel 315 may have a longitudinal length of greater than ten inches or greater than twelve inches (as examples) from the housing 300 (e.g., from the first end 311 to the second end 312).

In the example of FIG. 3, the speaker 118 has a single channel housing 310 and a single corresponding elongated channel 315 coupled to the back volume 306. However, in other implementations, a directional acoustic device such as the speaker 118 may have more than one channel housing defining more than one corresponding elongated channel coupled to the back volume 306.

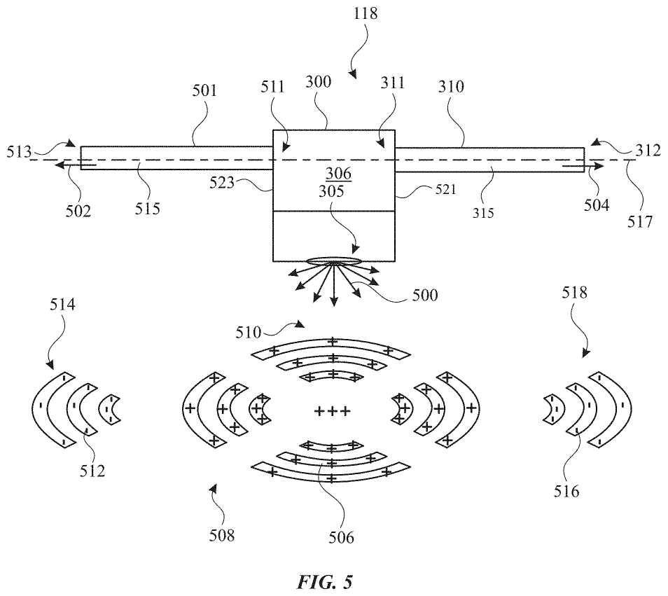

For example, FIG. 5 illustrates an example in which the channel housing 310 is a first channel housing and the elongated channel 315 is a first elongated channel, and the speaker 118 includes a second channel housing (e.g., channel housing 501) extending from the housing 300 and defining a second elongated channel (e.g., elongated channel 515). In this example, the elongated channel 515 includes a first end 511 that is fluidly coupled to the back volume 306 and a second end 513 that is fluidly coupled to the external environment of the speaker 118. As with the channel housing 310, the channel housing 501 may include one or more slots (e.g., longitudinal slots such as slot 314 of FIG. 3 and/or transverse slots such as slots 400 of FIG. 4) that fluidly couple the elongated channel 515 with the external environment at one or more locations between the first end 511 and the second end 513. For example, the channel housing 501 may include one or more slots that extend along the length of the channel housing 501 in parallel with a longitudinal axis of the channel housing 501 and the elongated channel 515 defined therein (e.g., as in the example of the slots 314 of the channel housing 310 of FIG. 3), and/or one or more slots that are oriented transversely to the longitudinal axis of the channel housing 501 and are spaced apart along the length of the channel housing 501 in a direction that is parallel with the longitudinal axis of the channel housing 501 and the elongated channel 515 defined therein (e.g., as in the example of the slots 400 of the channel housing 310 of FIG. 4).

In the example of FIG. 5, the elongated channel 315 and the elongated channel 515 extend along a common longitudinal axis 517 from opposing sidewalls 521 and 523 of the housing 300. However, in other implementations, the elongated channel 315 and the elongated channel 515 may extend from the opposing sidewalls 521 and 523 of the housing 300 along laterally separated parallel longitudinal axes, or along longitudinal axes that are not parallel, to direct negative polarity sound from the back volume 306 to any of various desired locations and/or directions in the external environment for which cancellation or suppression of sound emitted from the acoustic port 305 is desired.

In the example of FIG. 5, a positive polarity sound 506 may be projected substantially omnidirectionally (e.g., over a hemisphere, in this example) from the acoustic port 305, as indicated by arrows 500. As shown, the positive polarity sound 506 propagates from the acoustic port 305 to regions 508, 510, 514, and 518 in the external environment of the speaker 118. However, FIG. 5 also illustrates how negative polarity sound 512 is projected, in a direction 502, from the elongated channel 515 defined by channel housing 501 to the region 514, and negative polarity sound 516 is projected, in a direction 504, from the elongated channel 315 defined by channel housing 310 to the region 518. The negative polarity sound 512 may thus cancel at least a portion of the positive polarity sound 506 that is present in the region 514, and the negative polarity sound 516 may thus cancel at least a portion of the positive polarity sound 506 that is present in the region 518. In this way, the speaker 118 may generate audible sound at various locations and suppress or cancel the audible sound to generate one or more areas of relative quiet in the external environment of the speaker 118.

FIG. 6 illustrates an example in which the speaker 118 of FIG. 5 is implemented in an enclosed environment, in accordance with one or more implementations. In the example of FIG. 6, a top view of elements of the apparatus 100 of FIG. 1 are shown, including the speaker 118 mounted at or near the top of the enclosed environment 131 defined by the enclosure 108. For example, the speaker 118 may mounted to and/or partially within the support structure 104 of FIG. 1 in one or more implementations.

As shown in FIG. 6, the apparatus 100 may include an enclosure 108 having one or more acoustically reflective portions such as reflective surfaces 112 and defining an enclosed environment 131. For example, the acoustically reflective portions may be formed by planar or curved glass structures. In one or more implementations, the reflective surfaces 112 of the enclosure 108 may be implemented as windows or portions of a door of a room (e.g., a conference room in a building) or of a moveable platform (e.g., vehicle, such as an autonomous or semiautonomous vehicle).

In the example of FIG. 6, the apparatus 100 includes a seat 600 within the enclosed environment 131 for an occupant, and a speaker 118 (e.g., a directional speaker) configured to direct audio output toward the seat 600 and to cancel at least a portion of the audio output in a region (e.g., region 514) that is within the enclosed environment 131 and adjacent the acoustically reflective portion of the enclosure. The audio output from the speaker may be a positive polarity audio output (e.g., positive polarity sound 506) projected from an acoustic port (e.g., acoustic port 305) of the speaker 118. As shown, in this implementation, the speaker 118 includes an elongated channel 515 fluidly coupled to a back volume 306 of the speaker 118, and the speaker 118 is configured to cancel at least the portion of the audio output in the region 514 within the enclosure 108 and adjacent one of the acoustically reflective portions (e.g., reflective surface 112) of the enclosure 108, by projecting a negative polarity audio output (e.g., negative polarity sound 512) from the back volume 306 through the elongated channel 515.

In one or more implementations, the apparatus 100 may be implemented as a moveable platform such as a vehicle (e.g., an autonomous vehicle that navigates roadways using sensors and/or cameras and substantially without control by a human operator, a semiautonomous that includes human operator controls and that navigates roadways using sensors and/or cameras with the supervision of a human operator, or a vehicle with the capability of switching between a fully autonomous driving mode, a semiautonomous driving mode, and/or a human controlled mode). In various versions of such an implementation, any or all of the seats of the apparatus may be oriented toward the interior of the vehicle or facing out the sides of the vehicle (e.g., the left and/or right sides and/or the front and/or rear sides of the vehicle), facing toward the front of the vehicle, facing toward the rear of the vehicle, and/or rotatable between various orientations.

In the example of FIG. 6, the seat 600 is a first seat facing in a first direction (e.g., a forward direction of a vehicle) and the elongated channel 515 is a first elongated channel. In this example, the apparatus 100 (e.g., the autonomous or semiautonomous vehicle) includes a second seat (e.g., seat 604) in the enclosed environment 131 facing in a second direction opposite the first direction. For example, the seat 600 may include a seatback 602 that has seatback surface configured to interface with an occupant seated in the seat 600, and the seatback 602 may define the direction in which the seat 600 faces. For example, the seat 604 may include a seatback 606 that has seatback surface configured to interface with an occupant seated in the seat 604, and the seatback 606 may define the direction in which the seat 604 faces. In the example of FIG. 6, seat 604 faces the seat 600, and may also be facing a rear of the apparatus 100. However, this is merely illustrative and, in other implementations, the seat 604 may face in the same direction as the seat 600 (e.g., toward the front of a vehicle). In one or more implementations, the seat 604 may be rotatable from an orientation that faces in the same direction as the seat 600 (e.g., toward the front of a vehicle, such as in a human operator mode or a semi-autonomous mode) to an orientation that faces toward the seat 600 (e.g., in the opposite direction of the seat 600, such as in an autonomous driving mode) or to another orientation such as facing out the left or right side of the vehicle (e.g., in the autonomous driving mode).

In one or more implementations, the acoustically reflective portion of the enclosure 108 may be formed from a first curved glass structure mounted to and extending from a first side of a central support structure (e.g., support structure 104 of FIG. 1) that runs from a front end of the autonomous or semiautonomous vehicle to a rear end of the autonomous or semiautonomous vehicle. In the example of FIG. 6, the apparatus 100 (e.g., the autonomous or semiautonomous vehicle) includes a second acoustically reflective portion (e.g., a second reflective surface 112, such as a surface of a second curved glass structure mounted to and extending from a second side of the central support structure). As shown the second acoustically reflective portion may be disposed adjacent the region 518 and opposite the first acoustically reflective portion that is adjacent the region 514.

In the example of FIG. 6, the speaker 118 includes an elongated channel 315 (e.g., a second elongated channel in this example) fluidly coupled to the back volume 306 of the speaker 118, and the speaker 118 is further configured to project the positive polarity audio output (e.g., the positive polarity sound 506) from the acoustic port 305 toward the seat 604 and to cancel at least a portion of the audio output in a region 518 within the enclosure 108 and adjacent the second curved glass structure by projecting the negative polarity audio output (e.g., negative polarity sound 516) from the back volume 306 through the elongated channel 315.

In the example of FIG. 6, the speaker 118 may be implemented using the structures shown in FIG. 3 and/or FIG. 5, including a housing 300, an acoustic port 305 in the housing 300 and facing in a first direction, and a pair of directional audio features (e.g., a pair of elongated channels such as the elongated channel 315 and the elongated channel 515) that extend in respective second and third directions from the housing, the second and third directions substantially opposite to each other and substantially perpendicular to the first direction. In this example, an audio output (e.g., the negative polarity sound 512) from a first of the pair of directional features (e.g., the elongated channel 515) cancels at least the portion of the audio output (e.g., a portion of the positive polarity sound 506) in the region 514 within the enclosed environment 131 and adjacent the acoustically reflective portion (e.g., the reflective surface 112 adjacent the region 514) of the enclosure 108, and an audio output (e.g., the negative polarity sound 516) from a second of the pair of directional features (e.g., the elongated channel 315) cancels at least another portion of the audio output in another region (e.g., region 518) within the enclosed space and adjacent another acoustically reflective portion (e.g., the reflective surface 112 adjacent the region 518) of the enclosure. As in the examples of FIGS. 3 and 4, each of the pair of directional features (e.g., the elongated channel 515 and the elongated channel 315 formed, respectively, by the channel housing 501 and the channel housing 310) includes one or more slots (e.g., one or more slots 314 and/or one or more slots 400) that allow a portion of a negative polarity audio output from a back volume 306 of the speaker 118 to exit the respective directional feature into the enclosed environment 131.

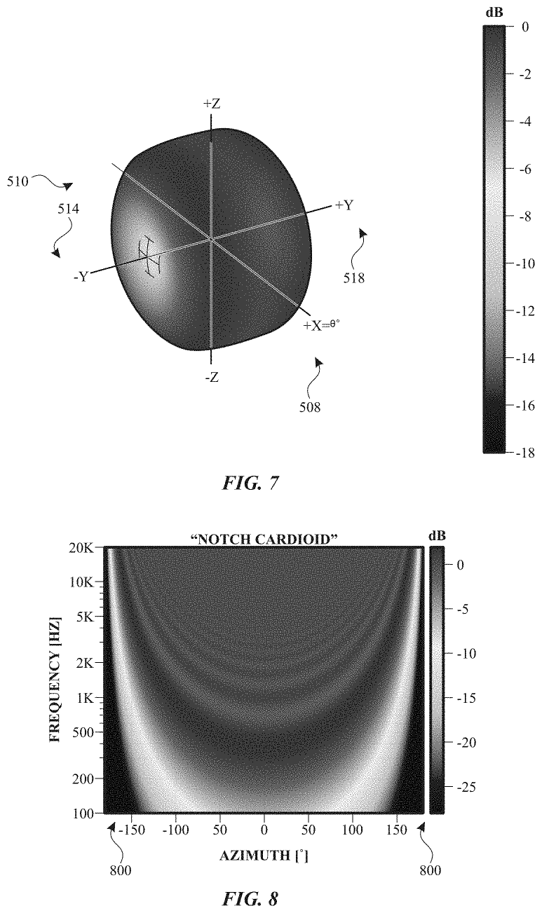

In the examples of FIGS. 5 and 6, the speaker 118 includes two directional audio features (e.g., the elongated channel 515 and the elongated channel 315 formed, respectively, by the channel housing 501 and the channel housing 310) that extend in opposite directions from the housing 300. FIG. 7 illustrates a three-dimensional representation of the audio power of the speaker 118 in an implementation in which positive polarity sound is emitted omnidirectionally from the speaker 118, and the speaker 118 includes two directional audio features (e.g., the elongated channel 515 and the elongated channel 315 formed, respectively, by the channel housing 501 and the channel housing 310) that extend in opposite directions from the housing 300. As shown in FIG. 7, the emission of the audible sound is projected into the regions 508 and 510 (e.g., in the positive and negative “x” directions in the figure), and cut off from projecting into the regions 514 and 518 (e.g., in the positive and negative “y” directions in the figure). FIG. 8 illustrates a two-dimensional representation of audio power as a function of azimuth and frequency, showing that the speaker 118 of FIGS. 5 and 6 can generate a “notch cardioid” emission pattern having emission bands 800 that are substantially narrower than a conventional cardioid pattern.

Although the examples of FIGS. 5 and 6 illustrate a speaker 118 that includes two directional audio features (e.g., the elongated channel 515 and the elongated channel 315 formed, respectively, by the channel housing 501 and the channel housing 310) for cancelling sound from the speaker in two corresponding directions, the speaker 118 may include one or more additional directional features that extend in one or more other directions for which cancellation or suppression of the emitted sound of the speaker is desired.

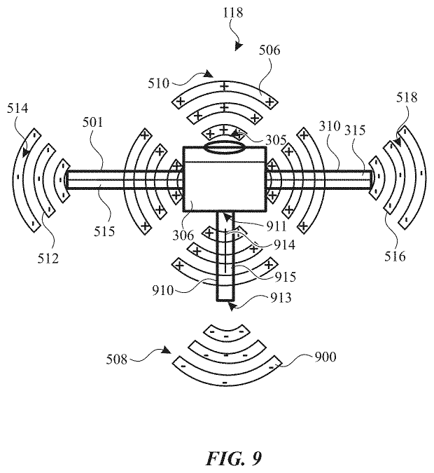

For example, FIG. 9 illustrates an implementation in which the speaker 118 includes a third channel housing 910 extending from the housing 300 and defining a third elongated channel 915 with a first end 911 that is fluidly coupled to the back volume 306 and a second end 913 that is fluidly coupled to the external environment of the speaker 118. As shown, the third channel housing 910 may include a slot 914 that fluidly couples the third elongated channel 915 with the external environment at a location between the first end 911 and the second end 913. In this example, the third elongated channel 915 extends along a longitudinal axis that is substantially perpendicular to the common longitudinal axis (e.g., the common longitudinal axis 517 shown in FIG. 5) of the elongated channel 515 and the elongated channel 315.

In the example of FIG. 9, negative polarity sound 900 emitted from the back volume 306 via the third elongated channel 915 cancels a portion of the positive polarity sound 506 in the region 508. In one or more implementations, the speaker 118 in the configuration of FIG. 9 may be mounted differently in an apparatus 100 than the speaker 118 in the configuration of FIGS. 5 and 6. For example, in the configuration of FIGS. 5 and 6, the speaker 118 may be mounted with the acoustic port 305 facing downward (e.g., toward a floor of the apparatus) or upward (e.g., toward a ceiling of the apparatus), such as to primarily project audible sound in forward and rearward directions within the apparatus 100, while cancelling or suppressing sound in left and right directions.

In the configuration of FIG. 9, the speaker 118 (e.g., including three directional components) may be mounted within the apparatus 100 such that the acoustic port 305 faces a seat (e.g., seat 600 or seat 604) within the apparatus, and cancels the audio output in the direction of one or more other seats and/or one or more non-occupant locations within the apparatus. This configuration can be useful, for example, for directing personalized audio content (e.g., personalized notifications) to a particular occupant within the enclosure 108. For example, the speaker 118 in the configuration of FIG. 9 may be used to notify an occupant in a particular seat within an autonomous or semiautonomous vehicle that the autonomous or semiautonomous vehicle has reached the destination of that occupant, to play audio corresponding to video being viewed by that occupant (e.g., on a personalized video screen for that occupant or personal device of that occupant), and/or to provide any other personized audio content to a particular occupant at a particular location toward which the acoustic port 305 faces.

In the examples of FIGS. 3-9, the directional audio cancelling features of the speaker 118 are provided whenever the speaker 118 is operating (e.g., passively due to the venting of back volume pressure through the elongated channels). In some use cases, it may also be desirable to be able to selectively use the directional audio cancelling features of a directional speaker.

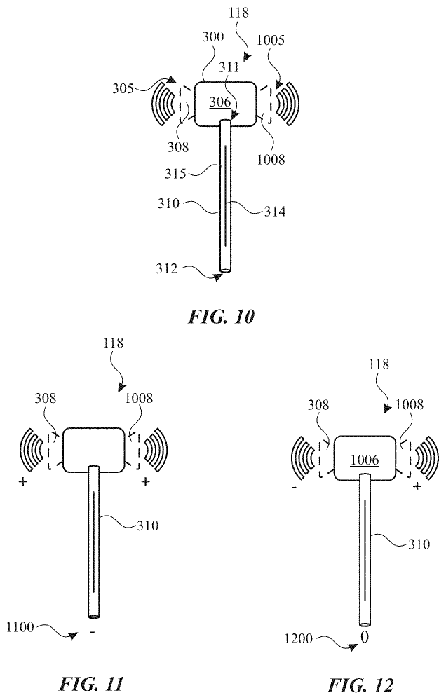

FIG. 10 illustrates an example in which the directional audio cancelling features of a directional speaker, such as speaker 118, can be selectively activated and deactivated. In the example of FIG. 10, speaker 118 is provided with multiple sound-generating elements that can be operated in-phase or out-of-phase. In the example of FIG. 10, a single channel housing 310 and corresponding elongated channel 315 and slot 314 are shown, for simplicity of the discussion of the multiple sound-generating elements. However, it is appreciated that the speaker 118 of FIG. 10 can be provided with two elongated channels as in the examples of FIGS. 5 and 6, three elongated channels as in the example of FIG. 9, or any suitable number of elongated channels coupled to the back volume 306.

In the example of FIG. 10, speaker 118 includes, in addition to the acoustic port 305 and the diaphragm 308 described in, for example, FIG. 3, an additional acoustic port 1005 in the housing 300. As shown, the acoustic port 305 and the additional acoustic port 1005 may face in directions that are substantially opposite and substantially perpendicular to the direction along which the channel housing 310 extends in one or more implementations. For example, in an implementation in which the speaker 118 includes two elongated channels from the back volume 306 (e.g., acoustic ducts defined by the channel housing 310 and the channel housing 501, as in the examples of FIGS. 5 and 6), the acoustic port 305 may face in a first direction, elongated channels 315 and 515 defined respectively by the channel housing 310 and the channel housing 501 may face in second and third directions substantially perpendicular to the first direction, and the additional acoustic port 1005 may face in a fourth direction substantially opposite the first direction and substantially perpendicular to the second and third directions. In one or more other implementations (e.g., an implementation in which the speaker 118 includes a single elongated channel 315 as in the example of FIG. 10), the acoustic port 305 and the acoustic port 1005 may face in different directions that are not anti-parallel (e.g., substantially perpendicular directions or other relative different directions).

In the example of FIG. 10, the speaker 118 may include the diaphragm 308 (e.g., a first diaphragm that separates the acoustic port 305 from the back volume 306 of the speaker 118), and a second diaphragm 1008 that separates the additional acoustic port 1005 from the back volume 306 of the speaker 118. In this configuration, because the diaphragm 308 and the second diaphragm 1008 (e.g., interior surfaces of the diaphragm 308 and the second diaphragm 1008) interface with the same back volume 306, operating the diaphragm 308 and the second diaphragm 1008 in phase (e.g., to both output positive polarity sounds) causes pressure changes within the back volume 306 that cause negative polarity sound 1100 to be directed through the elongated channel 315 defined by the channel housing 310 (e.g., and/or through any other elongated channels coupled to the back volume), which cancels a portion of the positive polarity sound in the direction of the elongated channel 315 (e.g., as shown in FIG. 11). In this use case, the directional audio cancelling features of the speaker 118 are activated.

In another use case illustrated in FIG. 12, operating the diaphragm 308 and the second diaphragm 1008 out of phase (e.g., to output positive polarity sound from the acoustic port 1005 and negative polarity sound from the acoustic port 305) causes the pressure within the back volume 306 to remain substantially constant, in which case no sound (e.g., a zero output 1200) is projected through the elongated channel 315 defined by the channel housing 310 (e.g., and/or through any other elongated channels coupled to the back volume). In this use case, the directional audio cancelling features of the speaker 118 are deactivated. Thus, by modifying the in-phase/out-of-phase operation of the two speaker diaphragms, the directional audio suppression features of the speaker 118 can be turned on and off, in one or more implementations.

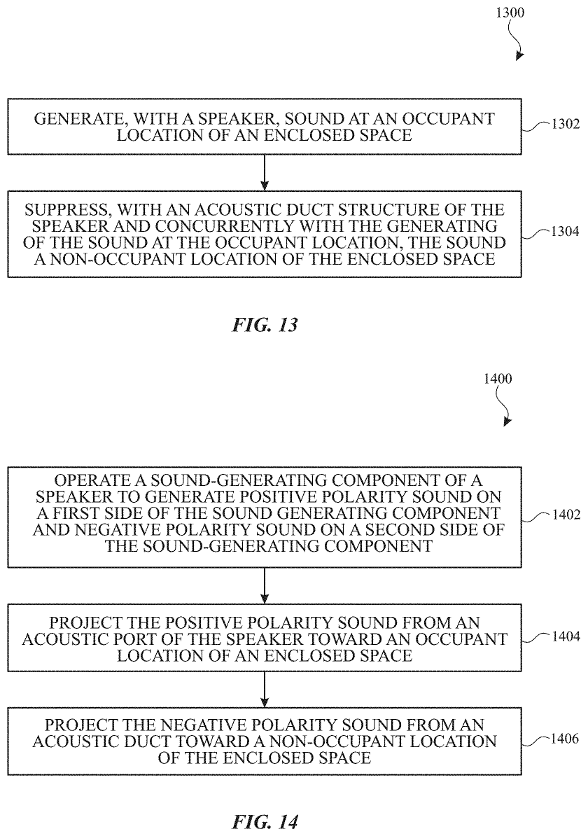

FIG. 13 illustrates a flow diagram of an example process 1300 for operating a directional acoustic device in accordance with implementations of the subject technology. For explanatory purposes, the process 1300 is primarily described herein with reference to the apparatus 100 and the speaker 118 of FIGS. 1-12. However, the process 1300 is not limited to the apparatus 100 and the speaker 118, and one or more blocks (or operations) of the process 1300 may be performed by one or more other components of other suitable devices or systems. Further for explanatory purposes, some of the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or can be replaced by other operations.

As illustrated in FIG. 13, at block 1302, a sound may be generated, with a speaker (e.g., speaker 118), at an occupant location (e.g., a location in the region 508 or a location within the region 510) of an enclosed space (e.g., enclosed environment 131). For example, the occupant location may be a location of a seat (e.g., an implementation of a support feature 117, such as a seat 600 or a seat 604) within the enclosed space. Generating the sound may include actuating a sound generating element of the speaker, such as a diaphragm 308 of the speaker 118. The sound may be a positive polarity sound (e.g., positive polarity sound 506) generated by the actuation of the diaphragm.

At block 1304, the sound may be suppressed, with an acoustic duct structure (e.g., an elongated channel, such as elongated channel 315, 515, and/or 915, that is fluidly coupled to a back volume 306 of the speaker and defined by a channel housing, such as channel housing 310, 501, and/or 910) of the speaker and concurrently with the generating of the sound at the occupant location, at a non-occupant location (e.g., a location within the region 514, the region 518, or the region 508) of the enclosed space. For example, the non-occupant location may be a location adjacent an acoustically reflective surface (e.g., reflective surface 112, such as a top housing structure 138 and/or a sidewall housing structure 140) of an enclosure (e.g., enclosure 108) defining the enclosed space.

For example, suppressing the sound at the non-occupant location may include projecting, through the acoustic duct structure from a back volume of the speaker, a negative polarity version of the sound (e.g., negative polarity sound 512, negative polarity sound 516, or negative polarity sound 900) that cancels the portion of the positive polarity sound that is present at the non-occupant location. In one or more implementations, the sound may also be suppressed at one or more additional non-occupant locations, such as by projecting the negative polarity version of the sound through one or more additional acoustic duct structures that are fluidly coupled to the back volume of the speaker that is generating the positive polarity sound.

In one or more implementations generating the sound at the occupant location may include operating first and second speaker membranes in phase (e.g., as described herein in connection with FIGS. 10 and 11). In these implementations, the process 1300 may also include ceasing suppressing the sound at the non-occupant location of the enclosed space by operating the first and second speaker membranes out of phase (e.g., as described herein in connection with FIG. 12).

FIG. 14 illustrates a flow diagram of an example process 1400 that may be performed as part of, or separately from, the process 1300 of FIG. 13, in accordance with implementations of the subject technology. For explanatory purposes, the process 1400 is primarily described herein with reference to the apparatus 100 and the speaker 118 of FIGS. 1-12. However, the process 1400 is not limited to the apparatus 100 and the speaker 118 of FIGS. 1-12, and one or more blocks (or operations) of the process 1400 may be performed by one or more other components of other suitable devices or systems. Further for explanatory purposes, some of the blocks of the process 1400 are described herein as occurring in serial, or linearly. However, multiple blocks of the process 1400 may occur in parallel. In addition, the blocks of the process 1400 need not be performed in the order shown and/or one or more blocks of the process 1400 need not be performed and/or can be replaced by other operations.

As illustrated in FIG. 14, a sound may be generated, with a speaker (e.g., speaker 118), at an occupant location (e.g., a location within the region 508 or a location within the region 510) of an enclosed space (e.g., the enclosed environment 131 defined by the enclosure 108) by, at block 1402, operating a sound-generating component (e.g., diaphragm 308) of the speaker to generate positive polarity sound (e.g., positive polarity sound 506) on a first side of the sound-generating component and negative polarity sound (e.g., negative polarity sound 512, 516, and/or 900) on a second side of the sound-generating component, and, at block 1404, projecting the positive polarity sound from an acoustic port (e.g., acoustic port 305) of the speaker toward the occupant location of the enclosed space.

As illustrated in FIG. 14, the sound may be suppressed, with an acoustic duct structure (e.g., elongated channel 315 defined by channel housing 310, elongated channel 515 defined by channel housing 501, and/or elongated channel 915 defined by channel housing 910) of the speaker and concurrently with the generating of the sound at the occupant location, at a non-occupant location (e.g., a location within the region 514 and/or a location within the region 518) of the enclosed space by, at block 1406, projecting the negative polarity sound from the acoustic duct structure toward the non-occupant location of the enclosed space. In one or more implementations, the process 1300 and/or the process 1400 may also include suppressing the sound, with an additional acoustic duct structure of the speaker and concurrently with the generating of the sound at the occupant location and the suppressing of the sound at the non-occupant location, at an additional non-occupant location of the enclosed space (e.g., as described herein in connection with, for example, FIGS. 5, 6, and/or 9).

Various processes defined herein consider the option of obtaining and utilizing a user's personal information. For example, such personal information may be utilized in order to provide personalized audio from a directional acoustic device. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

In accordance with aspects of the subject disclosure, an acoustic device is provided that includes a diaphragm mounted in a housing; a front volume on a first side of the diaphragm; a back volume on an opposing second side of the diaphragm and at least partially defined by the housing; an acoustic port fluidly coupling the front volume to an external environment of the acoustic device; and a channel housing extending from the housing and defining an elongated channel with a first end that is fluidly coupled to the back volume and a second end that is fluidly coupled to the external environment, the channel housing having a slot that fluidly couples the elongated channel with the external environment at a location between the first end and the second end.

In accordance with aspects of the subject disclosure, an apparatus is provided that includes an enclosure having an acoustically reflective portion and defining an enclosed environment; a seat within the enclosed environment for an occupant; and a directional speaker configured to direct audio output toward the seat and to cancel at least a portion of the audio output in a region that is within the enclosed environment and adjacent the acoustically reflective portion of the enclosure.

In accordance with aspects of the subject disclosure, a method is provided that includes generating, with a speaker, sound at an occupant location of an enclosed environment; and suppressing the sound, with an acoustic duct structure of the speaker and concurrently with the generating of the sound at the occupant location, at a non-occupant location of the enclosed environment.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neutral gender (e.g., her and its) and vice versa. Headings and subheadings, if any, are used for convenience only and do not limit the subject disclosure.

What is claimed is:

1. An acoustic device, comprising;
a diaphragm mounted in a housing;
a front volume on a first side of the diaphragm;
a back volume on an opposing second side of the diaphragm and at least partially defined by the housing;
an acoustic port fluidly coupling the front volume to an external environment of the acoustic device; and
a channel housing extending from the housing and defining an elongated channel with a first end that is fluidly coupled to the back volume and a second end that is fluidly coupled to the external environment, the channel housing having a slot that fluidly couples the elongated channel with the external environment at a location between the first end and the second end.

2. The acoustic device of claim 1, wherein the acoustic device is configured to:
project positive polarity sound, generated by a motion of the diaphragm, through the acoustic port; and
project negative polarity sound, generated by the motion of the diaphragm, through the elongated channel.

3. The acoustic device of claim 2,
wherein the positive polarity sound, when projected through the acoustic port, generates audible sound in a first region of the external environment of the acoustic device, and
wherein the negative polarity sound, when projected through the elongated channel, cancels at least a portion of the positive polarity sound in a second region of the external environment.

4. The acoustic device of claim 1, wherein the acoustic port is aligned in a first direction and the elongated channel is aligned in a second direction substantially perpendicular to the first direction.

5. The acoustic device of claim 4, wherein the channel housing is a first channel housing and the elongated channel is a first elongated channel, the acoustic device further comprising a second channel housing extending from the housing and defining a second elongated channel with a first end that is fluidly coupled to the back volume and a second end that is fluidly coupled to the external environment, the second channel housing having a slot that fluidly couples the second elongated channel with the external environment at a location between the first end and the second end of the second elongated channel.

6. The acoustic device of claim 5, wherein the elongated channel and the second elongated channel extend along a common longitudinal axis from opposing sidewalls of the housing.

7. The acoustic device of claim 6, further comprising a third channel housing extending from the housing and defining a third elongated channel with a first end that is fluidly coupled to the back volume and a second end that is fluidly coupled to the external environment, the third channel housing having a slot that fluidly couples the third elongated channel with the external environment at a location between the first end and the second end of the third channel housing, wherein the third elongated channel extends along a longitudinal axis that is substantially perpendicular to the common longitudinal axis of the first elongated channel and the second elongated channel.

8. An apparatus, comprising:
an enclosure having an acoustically reflective portion and defining an enclosed environment;
a seat within the enclosed environment for an occupant; and
a directional speaker configured to direct an audio output toward the seat and to cancel at least a portion of the audio output in a region that is within the enclosed environment and adjacent the acoustically reflective portion of the enclosure.

9. The apparatus of claim 8, wherein the audio output is a positive polarity audio output projected from an acoustic port of the directional speaker, wherein the directional speaker comprises an elongated channel fluidly coupled to a back volume of the directional speaker, and wherein the directional speaker is configured to cancel at least the portion of the audio output in the region within the enclosure and adjacent the acoustically reflective portion of the enclosure by projecting a negative polarity audio output from the back volume through the elongated channel.

10. The apparatus of claim 9, wherein the apparatus comprises a conference room in a building, or a moveable platform.

11. The apparatus of claim 10, wherein the apparatus comprises the moveable platform, wherein the moveable platform comprises an autonomous vehicle, wherein the seat is a first seat facing in a first direction and the elongated channel is a first elongated channel, wherein the autonomous vehicle comprises a second seat in the enclosed environment facing in a second direction opposite the first direction, wherein the acoustically reflective portion of the enclosure comprises a first curved glass structure mounted to and extending from a first side of a central support structure that runs from a front end of the autonomous vehicle to a rear end of the autonomous vehicle, wherein the autonomous vehicle further comprises a second curved glass structure mounted to and extending from a second side of the central support structure, wherein the directional speaker comprises a second elongated channel fluidly coupled to the back volume of the directional speaker, and wherein the directional speaker is further configured to project the positive polarity audio output from the acoustic port toward the second seat and to cancel at least a portion of the audio output in a region within the enclosure and adjacent the second curved glass structure by projecting the negative polarity audio output from the back volume through the second elongated channel.

12. The apparatus of claim 8, wherein the directional speaker comprises:
a housing;
an acoustic port in the housing and facing in a first direction; and
a pair of directional audio features that extend in respective second and third directions from the housing, the second and third directions substantially opposite to each other and substantially perpendicular to the first direction.

13. The apparatus of claim 12, wherein an audio output from a first of the pair of directional audio features cancels at least the portion of the audio output in the region within the enclosed environment and adjacent the acoustically reflective portion of the enclosure, and wherein an audio output from a second of the pair of directional audio features cancels at least another portion of the audio output in another region within the enclosed environment and adjacent another acoustically reflective portion of the enclosure.

14. The apparatus of claim 12, wherein each of the pair of directional audio features comprises a slot that allows a portion of a negative polarity audio output from a back volume of the directional speaker to exit the respective directional audio feature into the enclosed environment.

15. The apparatus of claim 12, wherein the directional speaker further comprises:
an additional acoustic port in the housing and facing in a fourth direction substantially opposite the first direction and substantially perpendicular to the second and third directions;
a first diaphragm that separates the acoustic port from a back volume of the directional speaker; and
a second diaphragm that separates the additional acoustic port from the back volume of the directional speaker.

16. A method, comprising:
generating, with a speaker, sound at an occupant location of an enclosed environment; and
suppressing the sound, with an acoustic duct structure of the speaker and concurrently with the generating of the sound at the occupant location, at a non-occupant location of the enclosed environment.

17. The method of claim 16, wherein:
generating the sound at the occupant location comprises:
operating a sound-generating component of the speaker to generate positive polarity sound on a first side of the sound-generating component and negative polarity sound on a second side of the sound-generating component; and
projecting the positive polarity sound from an acoustic port of the speaker toward the occupant location of the enclosed environment; and
suppressing the sound at the non-occupant location of the enclosed environment comprises:
projecting the negative polarity sound from the acoustic duct structure toward the non-occupant location of the enclosed environment.

18. The method of claim 16, wherein the occupant location comprises a location of a seat within the enclosed environment, and wherein the non-occupant location comprises a location adjacent an acoustically reflective surface of an enclosure defining the enclosed environment.

19. The method of claim 16, further comprising suppressing the sound, with an additional acoustic duct structure of the speaker and concurrently with the generating of the sound at the occupant location and the suppressing of the sound at the non-occupant location, at an additional non-occupant location of the enclosed environment.

20. The method of claim 16, wherein generating the sound at the occupant location comprises operating first and second speaker membranes in phase, the method further comprising:
ceasing suppressing the sound at the non-occupant location of the enclosed environment by operating the first and second speaker membranes out of phase.
